(19) United States
(12) Patent Application Publication
(10) Pub. No.: US 2026/0245221 A1
(43) Pub. Date: Aug. 20, 2026

(54) TRACKING METHOD AND HEAD-MOUNTED DISPLAY DEVICE

(71) Applicant: HTC Corporation, Taoyuan City (TW)

(72) Inventor: Chun-Kai HUANG, Taoyuan City (TW)

(21) Appl. No.: 19/057,926

(22) Filed: Feb. 19, 2025

(51) Int. Cl. G06T 7/246; G06F 3/01; G06T 7/73

(52) U.S. Cl. CPC G06T 7/248; G06F 3/012; G06T 7/74

(57) ABSTRACT

A tracking method include following steps. In response to a camera tracker establishing a tracker keyframe, a keyframe viewport data associated with the tracker keyframe is transmitted from the camera tracker to a head-mounted display device. A current frame is captured by the head-mounted display device. Based on the keyframe viewport data, whether the current frame meets shared keyframe criteria is determined. In response to the current frame meets the shared keyframe criteria, a shared keyframe is established based on the current frame by the head-mounted display device. The shared keyframe is transmitted from the head-mounted display device to the camera tracker.

### BACKGROUND

### Field of Invention

The disclosure relates to a tracking method for an immersive system. More particularly, the disclosure relates to the tracking method involving a head-mounted display device and a camera tracker in the immersive system.

### Description of Related Art

In recent years, virtual reality has gained significant traction across various applications, from gaming and training simulations to remote operating systems. Despite advancements, a persistent challenge remains in providing users with a seamless and intuitive experience that effectively bridges the gap between physical and virtual worlds. Current systems often lack the ability to precisely track and interpret complex physical gestures, thus limiting the user's immersive experience and the efficiency of interactions within a virtual environment.

In order to provide an immersive experience to the user, it is required to track body movements of the user. In some cases, some body-mounted trackers may be worn on different body parts (e.g., wrists, ankles, waist) of the user, such that the body movements can be tracked based on these body-mounted trackers. Based on a tracking result of the body movements, the head-mounted display device can render the immersive content accordingly, so as to fulfill interactions between a virtual world and a real world.

### SUMMARY

The disclosure provides a tracking method include following steps. In response to a camera tracker establishing a tracker keyframe, a keyframe viewport data associated with the tracker keyframe is transmitted from the camera tracker to a head-mounted display device. A current frame is captured by the head-mounted display device. Based on the keyframe viewport data, whether the current frame meets shared keyframe criteria is determined. In response to the current frame meets the shared keyframe criteria, a shared keyframe is established based on the current frame by the head-mounted display device. The shared keyframe is transmitted from the head-mounted display device to the camera tracker.

The disclosure provides a head-mounted display device, which includes a camera, a storage unit, a transceiver circuit and a processor. The camera is configured to capture a current frame. The transceiver circuit is configured to receive a keyframe viewport data associated with a tracker keyframe from the camera tracker. The storage unit is configured to store the keyframe viewport data. The processor is coupled with the storage unit, the camera and the transceiver circuit. The processor is configured to determine whether the current frame meets shared keyframe criteria based on the keyframe viewport data. In response to the current frame meets the shared keyframe criteria, the processor is configured to establish a shared keyframe based on the current frame. The processor is configured to trigger the transceiver circuit to transmit the shared keyframe to the camera tracker.

The disclosure provides a tracking method include steps of capturing a current frame by a camera of a tracking device; computing a current frame pose according to the current frame; determining whether the current frame meets regular keyframe criteria; in response to that the current frame meets the regular keyframe criteria, establishing a new keyframe based on the current frame; in response to that the current frame fails to meet the regular keyframe criteria, searching historical keyframes stored in the tracking device for a target historical keyframe adjacent to the current frame pose; determining whether the target historical keyframe and the current frame meets a replacement keyframe criteria; and in response to that the target historical keyframe and the current frame meet the replacement keyframe criteria, establishing a replacement keyframe based on the current frame for replacing the target historical keyframe stored in the tracking device.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an immersive system according to an embodiment of this disclosure.

FIG. 2 is a schematic diagram illustrating the head-mounted display device, a camera tracker located in a real environment according to an embodiment of this disclosure.

FIG. 3 is a flow chart of a tracking method according to some embodiments of the disclosure.

FIG. 4 is a schematic diagram illustrating a tracker current frame captured by the camera tracker according to some embodiments of the disclosure.

FIG. 5 is a schematic diagram illustrating a first example of a current frame captured by the camera on the head-mounted display device according to some embodiments of the disclosure.

FIG. 6 is a schematic diagram illustrating a second example of a current frame captured by the camera on the head-mounted display device according to some embodiments of the disclosure.

FIG. 7 is a flow chart of a tracking method according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

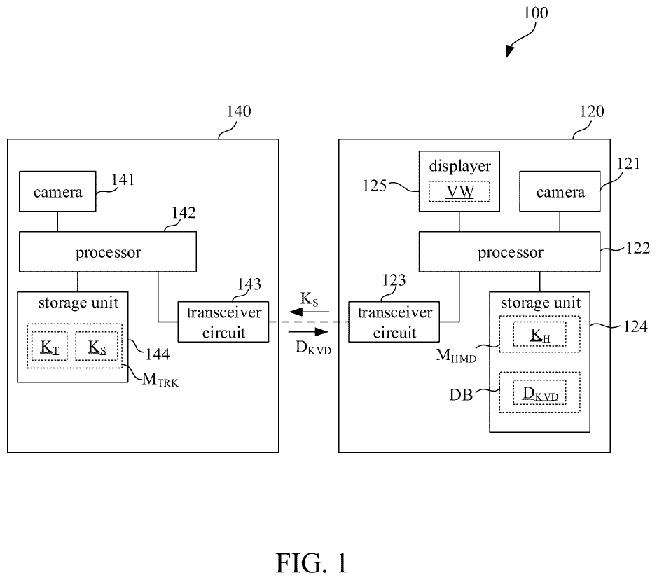

Reference is made to FIG. 1, which is a schematic diagram illustrating an immersive system 100 according to an embodiment of this disclosure. As shown in FIG. 1, the immersive system 100 includes a head-mounted display (HMD) device 120, a camera tracker 140. As shown in FIG. 1, the head-mounted display device 120 may include a camera 121, a processor 122, a transceiver circuit 123, a storage unit 124 and a displayer 125. The displayer 125 is configured to display a virtual environment VW to the user.

The camera 121 can be implemented by a CMOS image sensor, CCD image sensor, a depth camera or similar component. The processor 122 can be implemented by a central processing unit (CPU), a graphic processing unit (GPU), a tensor processing unit (TPU), an application-specific integrated circuit (ASIC) or similar component. The transceiver circuit 123 can be implemented by a WiFi transceiver circuit, a Bluetooth transceiver or similar component. The storage unit 124 can be implemented by a hard disk drive, a solid state drive, a flash drive, a random access memory or a read-only memory. The displayer 125 can be implemented by using high-resolution OLED or LCD panels, providing vibrant colors and wide viewing angles. It integrates with lenses to project immersive 3D visuals, ensuring a seamless virtual reality experience by adjusting focus and depth perception dynamically.

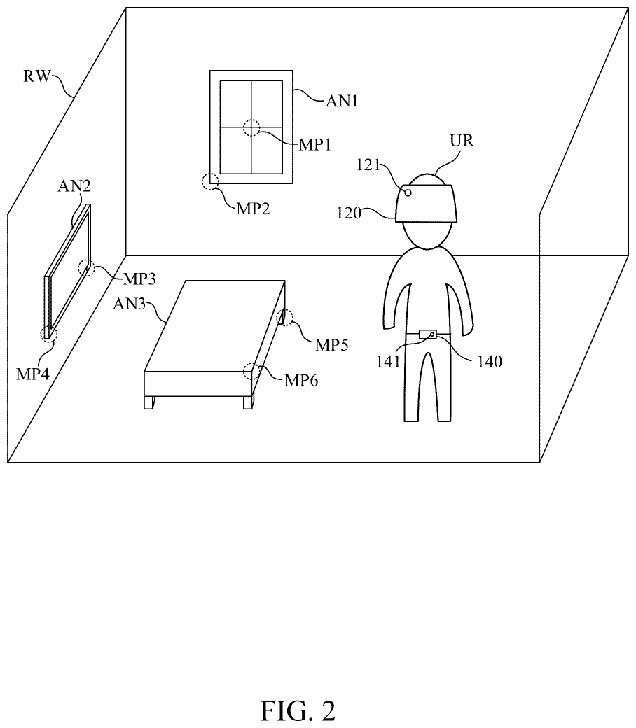

Reference is further made to FIG. 2, which is a schematic diagram illustrating the head-mounted display (HMD) device 120, a camera tracker 140 located in a real environment RW according to an embodiment of this disclosure.

In order to provide an immersive experience to the user UR, the immersive system 100 is configured to track a physical movement of the user, and provide an interaction between user's physical movement and the virtual environment VW. In this case, the head-mounted display device 120 is mounted on the head of the user UR, such that a movement, a displacement, acceleration and/or a rotation of the head-mounted display device 120 can be detected and utilized to track a head movement of the user UR.

For example, the real environment RW as shown in FIG. 2 can be an indoor space (e.g., a bedroom or a conference room) in a real world, but the disclosure is not limited thereto. In some other embodiments, the real environment RW can also be a specific area at an outdoor space (not shown in figures). On the other hand, the head-mounted display device 120 is configured to display a virtual environment VW to the user UR.

As shown in FIG. 2, the head-mounted display device 120 can be worn on the head of the user UR. In some embodiments, the camera 121 of the head-mounted display device 120 can be configured to capture streaming images. The processor 122 is coupled with the camera 121, and the processor 122 is able to run a Simultaneous Localization and Mapping (SLAM) algorithm to track the head movement based on the streaming images.

In some embodiments, SLAM is a computational algorithm executed by the head-mounted display device 120 to build a map of an unknown environment while simultaneously determining its location within that map. SLAM is crucial for various applications, including virtual reality, augmented reality, and autonomous vehicles, robotics, where accurate mapping and localization are essential.

The camera 121 is configured to capture streaming images. Based on the streaming images, the processor 122 is configured to detect key features in the environment and create some keyframes, so as to establish a mapdata M_{HMD} about an environment around the head-mounted display device.

The processor 122 continuously estimates the current position and orientation (pose) of the head-mounted display device 120 by comparing the detected features in the latest camera images against those in previously captured frames.

For example, the streaming images may cover an anchor item AN1 (e.g., a window), another anchor item AN2 (e.g., a television) and still another anchor item AN3 (e.g., a table) in the real environment RW as shown in FIG. 2. In most cases, positions of the anchor items AN1, AN2 and AN3 are fixed in the real environment RW. When these anchor items AN1, AN2 and AN3 appeared in streaming images captured by the camera 121. Visual features on these anchor items AN1, AN2 and AN3 can be recognized by SLAM algorithm as map points MP1, MP2, MP3, MP4, MP5 and MP6. The SLAM algorithm executed by the processor 122 may keep tracking gap distances of the head-mounted display device 120 relative to the map points MP1 to MP6. Therefore, the processor 122 is capable of obtaining a position (and/or a rotation) of the head-mounted display device 120 relative to these map points MP1 to MP6. In this case, the processor 122 is able to track the head-mounted display device 120.

As the user navigates the environment, the processor 122 executes SLAM to continually update the mapdata M_{HMD} with new information about the locations and features of the surroundings of the real world RW. Some frames captured by the camera 121 at significant positions are selected as keyframes to maintain accurate mapping. Keyframes are selected images or data frames in the SLAM algorithm that capture significant and stable views of the environment, serving as crucial reference points. These keyframes created by the head-mounted display device 120 are added into the mapdata M_{HMD}. Keyframes contain vital visual features of the environment, enabling the system to recognize revisited areas. Keyframes act as stable anchors in the mapping process, helping reduce drift errors in tracking and localization, thereby enhancing overall accuracy.

The mapdata M_{HMD} is the output generated by the SLAM algorithm, representing the spatial layout or model of the environment (e.g., the real world RW). The mapdata M_{HMD} contains essential features (e.g., keyframes) of the environment, such as object locations, shapes, and spatial arrangements, which are crucial for understanding the surroundings. The mapdata M_{HMD} can stored in the storage unit 124. As the head-mounted display device 120 moves, mapdata M_{HMD} aids in continuous localization by updating the device's position relative to the known map, ensuring accurate positional tracking.

The camera tracker 140 can be attached on a torso, a hand or a leg of the user UR. As shown in FIG. 2, the camera tracker 140 is worn on the waist of the user UR. However, the camera tracker 140 is not limited thereto. In some other embodiments, the immersive system 100 can include one or more camera tracker(s). The camera tracker(s) can be placed on wrists, thighs or ankles of the user UR.

In some embodiments, the camera tracker 140 may include a camera 141, a processor 142, a transceiver circuit 143 and a storage unit 144. Similar to aforementioned SLAM executed on the head-mounted display device 120, the camera 141 of the camera tracker 140 can be configured to capture streaming images. The processor 142 is coupled with the camera 141, and the processor 142 is able to run a Simultaneous Localization and Mapping (SLAM) algorithm to track a body movement (via the camera tracker 140) of the user UR.

Similar to the SLAM executed on the head-mounted display device 120 discussed above, the processor 142 also execute the SLAM algorithm, which continuously estimates the current position and orientation (pose) of the camera tracker 140 by comparing the detected features in the latest camera images against those in previously captured frames. By determining how these features have shifted, the SLAM algorithm computes the movement of the camera tracker 140. The camera 141 is configured to capture streaming images. Based on the streaming images, the processor 142 is configured to detect key features in the environment and create some keyframes, so as to establish a mapdata M_{TRK} about the environment around the camera tracker 140.

In some embodiments, the head-mounted display device 120 and the camera tracker 140 may construct a multi-SLAM system. The multi-SLAM system is designed to map and understand environments in real time using multiple sensors or cameras. Multi-SLAM is commonly utilized in robotics, augmented reality, and autonomous vehicles. In the multi-SLAM system, aligning the mapdata M_{HMD} and the mapdata M_{TRK} is important. Each SLAM device creates its own map based on its sensor data. To produce a unified and consistent map of the environment, the maps from each device must be accurately aligned. Alignment ensures that the positional and orientational information from each device is correct relative to one another, critical for tasks like navigation and interaction with the environment.

Aligning two SLAM devices (e.g., the head-mounted display device 120 and the camera tracker 140) involves determining the spatial relationship between their coordinate frames. In some embodiment, the alignment can be achieved by establishing a shared keyframe K_{S} by the head-mounted display device 120 and transmitting the shared keyframe K_{S} to the camera tracker 140. The shared keyframe K_{S} can added into the mapdata M_{TRK} stored in the storage unit 144.

The shared keyframe K_{S} may include common map points observable between two devices. These map points are observed by two devices in the same or overlapping regions of the environment. This requires feature matching between the keyframes to identify correspondences.

In some embodiments, when the camera tracker 140 captures a new tracker keyframe, the camera tracker 140 is configured to generate a keyframe viewport data (KVD) D_{KVD} associated with the tracker keyframe. The keyframe viewport data D_{KVD} will be transmitted from the camera tracker 140 to the head-mounted display device 120. Based on the keyframe viewport data D_{KVD}, the head-mounted display device 120 will establish the shared keyframe K_{S} accordingly.

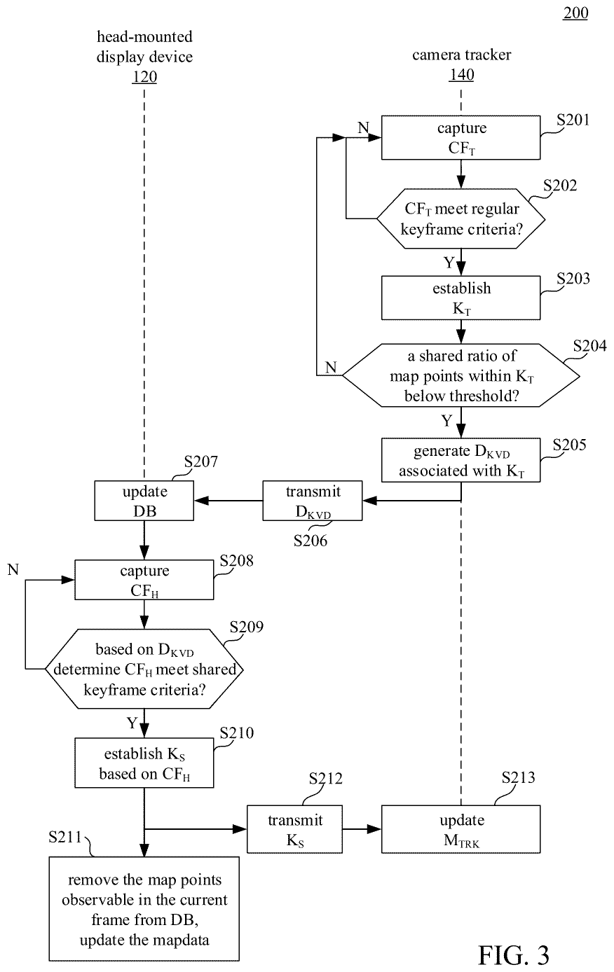

Reference is further made to FIG. 3, which is a flow chart of a tracking method 200 according to some embodiments of the disclosure. The tracking method 200 can be executed by the head-mounted display device 120 and the camera tracker 140 in aforesaid embodiments shown in FIG. 1 and FIG. 2.

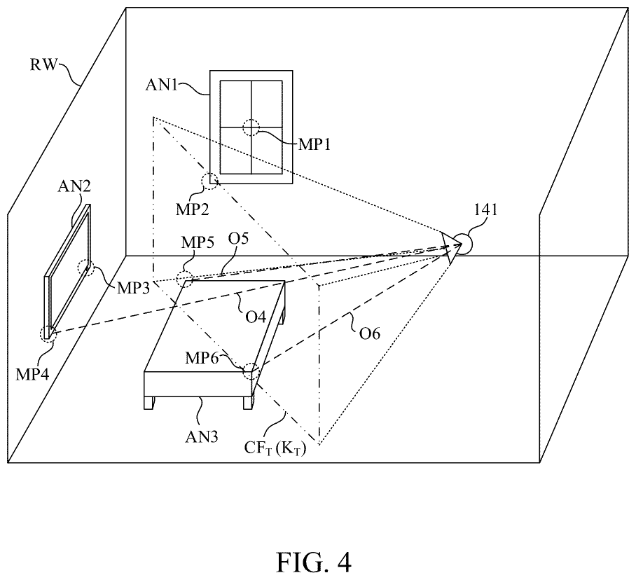

As shown in FIG. 1 and FIG. 3, in step S201, the camera 141 of the camera tracker 140 is configured to capture a tracker current frame CF_{T}. In step S202, the processor 142 of the camera tracker 140 is configured to determine whether the current frame meets regular keyframe criteria. Reference is further made to FIG. 4, which is a schematic diagram illustrating a tracker current frame CF_{T} captured by the camera tracker 140 according to some embodiments of the disclosure.

As shown in FIG. 4, a field of view from the camera 141 covers a specific area in the real environment RW, map points located in this specific area will appear in the view of the tracker current frame CF_{T}. In this embodiment shown in FIG. 4, the map points MP4, MP5 and MP6 will appear in the tracker current frame CF_{T}. In other words, the map points MP4, MP5 and MP6 are observable in field of view of the camera 141 while capturing the tracker current frame CF_{T}.

In step S202, the processor 142 of the camera tracker 140 is configured to determine whether the tracker current frame CF_{T} meets regular keyframe criteria. In some embodiments, the regular keyframe criteria is about counting a total number of the map points (e.g., the map points MP4, MP5 and MP6) in the tracker current frame CF_{T} matched with known map points existed in the mapdata M_{TRK}.

If the total number is relatively large, it means that the tracker current frame CF_{T} corresponds to a familiar scenario which can be recognized according to the mapdata M_{TRK}, and the tracker current frame CF_{T} fails to meet the regular keyframe criteria (i.e., there is no need to capture a new regular keyframe according to the tracker current frame CF_{T}).

On the other hand, if the total number is relatively small, it means the tracker current frame CF_{T} corresponds to an unfamiliar scenario which can be not recognized (or not accurately) according to the mapdata M_{TRK}, and the tracker current frame CF_{T} meets the regular keyframe criteria (i.e., a new regular keyframe is needed).

When the tracker current frame meets the regular keyframe criteria, step S203 is executed by the processor 142, to establish the tracker keyframe K_{T} based on the tracker current frame CF_{T}. In some embodiments, pixel data of the tracker current frame CF_{T} and extracted features (e.g., map points MP4, MP5 and MP6) are utilized to establish the tracker keyframe K_{T}.

During the process of establishing the tracker keyframe K_{T}, the SLAM system on the camera tracker 140 will attempt to create additional map points to address the issue of an unfamiliar environment. This ensures that the subsequent tracking can adapt to the current environment.

After the tracker keyframe K_{T} is established, step S204 is executed to check all map points within the tracker keyframe K_{T} and determines how many of these map points are shared map points. For instance, if the map points MP4, MP5, and MP6 are all non-shared map points (i.e., these map points do not exist in the HMD's map, the mapdata M_{HMD}), a shared ratio of the map points within the tracker keyframe K_{T} can be considered below a certain threshold, and step S205 will be executed. Conversely, if the map points MP4, MP5, and MP6 are all shared map points (i.e., these map points exist in the HMD's map, the mapdata M_{HMD}), the shared ratio of the map points within the tracker keyframe K_{T} can be considered above the threshold, and step S205 will not be executed. In this case, the process will return to step S201.

The threshold used in step S204 is influenced by the number of SLAM systems and the transmission capabilities between them. Therefore, it is not limited to a single proportional relationship. Further details are not elaborated here.

Step S205 is executed by the processor 142, to generate keyframe viewport data D_{KVD} associated with the tracker keyframe K_{T}.

In some embodiments, a viewport usually refers to the visible portion of an environment from a particular position and orientation of a sensor or camera. The viewport indicates what is currently being observed or what was observed by the camera 141 at the time the tracker keyframe K_{T} was captured.

In some embodiments, the keyframe viewport data D_{KVD} is a data used in the multi-SLAM systems. The keyframe viewport data D_{KVD} include the relevant information captured in the tracker keyframe K_{T} from a particular viewpoint. In some embodiments, the keyframe viewport data D_{KVD} include map points (e.g., the map points MP4, MP5 and MP6) in the tracker keyframe K_{T}, spatial distribution of the map points (e.g., orientations O4, O5 and O6 of the map points MP4, MP5 and MP6 relative to a central axis of the tracker keyframe K_{T}) in the tracker keyframe K_{T}. In some embodiments, the keyframe viewport data D_{KVD} further include depth data, sensor metadata (timestamps, sensor position and orientation) or feature descriptors of the map points MP4 to MP6 for matching and tracking.

In some embodiments, the keyframe viewport data D_{KVD} include a combination of at least one of map points in the tracker keyframe K_{T}, spatial distribution of the map points in the tracker keyframe K_{T}, the depth data, the sensor metadata and the feature descriptors of the map points.

In some embodiments, the keyframe viewport data D_{KVD} may not include raw pixel data or raw image data of the the tracker keyframe K_{T} (or the tracker current frame CF_{T}). The keyframe viewport data D_{KVD} include characteristic data about the map points and viewpoint relative to the map points, and not the raw pixel data or raw image data.

Step S206 is executed to transmit the keyframe viewport data D_{KVD} from the camera tracker 140, through the transceiver circuit 143 and the transceiver circuit 123, to the head-mounted display device 120.

When the keyframe viewport data D_{KVD} is received by the head-mounted display device 120, in step S207, the keyframe viewport data D_{KVD} are updated into a keyframe viewport database DB stored in the storage unit 124 of the head-mounted display device 120. In this embodiment, the map points MP4, MP5 and MP6 carried in the keyframe viewport data D_{KVD} will be added into the keyframe viewport database DB.

Step S208 is executed to capture a current frame CF_{H} overserved by the camera 121 on the head-mounted display device 120. In step S209, the processor 122 is configured to determine whether the current frame CF_{H} meets shared keyframe criteria based on the keyframe viewport data D_{KVD}.

Steps S208 and S209 are not necessarily executed in response to the keyframe viewport data D_{KVD} received in step S205. In some embodiments, step S208 and S209 are executed periodically (e.g., every 3 seconds) on the head-mounted display device 120 while the head-mounted display device 120 moving in the real environment RW.

As mentioned above, the keyframe viewport data D_{KVD} include the map points MP4, MP5 and MP6 appeared in the tracker keyframe K_{T}. In some embodiments, step S209 includes searching the current frame CF_{H} for the map points MP4, MP5 and MP6 carried in the keyframe viewport data D_{KVD}, and determining whether the current frame CF_{H} is able to observe a sufficient number of the map points from the keyframe viewport data.

If more map points carried in the keyframe viewport data D_{KVD} are observable in the current frame CF_{H}, it means that the current frame CF_{H} is a good alternative to replace the tracker keyframe K_{T} established by the camera tracker 140.

The current frame CF_{H} are observed and captured by the camera 121 on the head-mounted display device 120. In some cases, compared with the camera 141 on the camera tracker 140, the camera 121 on the head-mounted display device 120 may have a higher image resolution, such that the current frame CF_{H} captured by the camera 121 on the head-mounted display device 120 may provide a higher accuracy while performing SLAM tracking (compared with the tracker keyframe K_{T}).

On the other hand, if less map points carried in the keyframe viewport data D_{KVD} are observable in the current frame CF_{H}, it means that the current frame CF_{H} is not a good alternative to replace the tracker keyframe K_{T} established by the camera tracker 140.

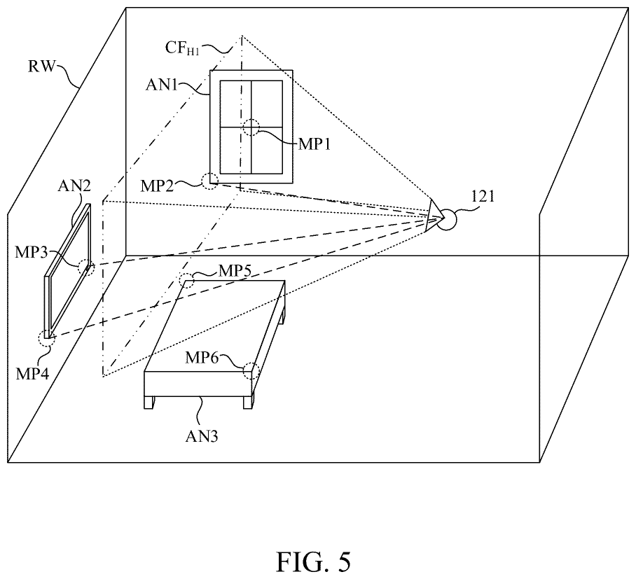

Reference is further made to FIG. 5, which is a schematic diagram illustrating a first example of a current frame CF_{H1} captured by the camera 121 on the head-mounted display device 120 according to some embodiments of the disclosure.

As the current frame CF_{H1} shown in FIG. 5, the current frame CF_{H1} is able to observe the map points MP2, MP3 and MP4. However, the map points MP5 and MP6 carried in the keyframe viewport data D_{KVD} are not observable in the current frame CF_{H1} as illustrated in FIG. 5. In this case, if a keyframe is established based on the current frame CF_{H1} captured by the camera 121 on the head-mounted display device 120, this keyframe based on the current frame CF_{H1} can be utilized for tracking the head-mounted display device 120 itself, but this keyframe based on the current frame CF_{H1} is not suitable for tracking the camera tracker 140 (because there is no sufficient common map points).

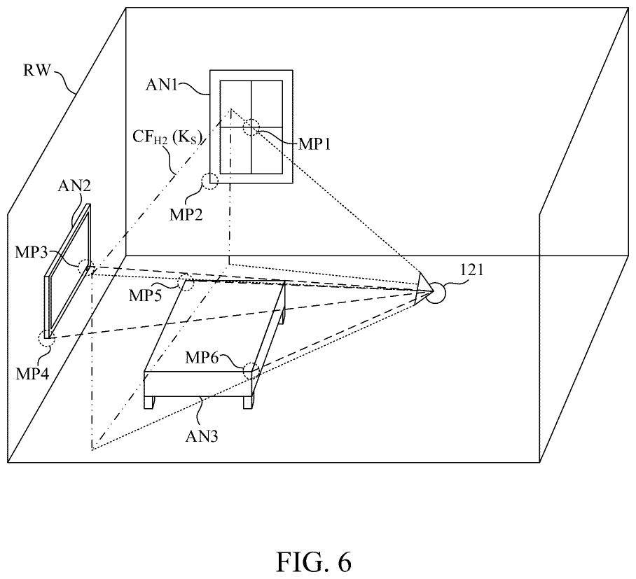

Reference is further made to FIG. 6, which is a schematic diagram illustrating a second example of a current frame CF_{H2} captured by the camera 121 on the head-mounted display device 120 according to some embodiments of the disclosure.

As the current frame CF_{H2} shown in FIG. 6, the current frame CF_{H2} is able to observe the map points MP3, MP4, MP5 and MP6. In other words, the map points MP4, MP5 and MP6 carried in the keyframe viewport data D_{KVD} are observable in the current frame CF_{H2} as illustrated in FIG. 6. In this case, the current frame CF_{H2} is qualified as meeting the shared keyframe criteria. The aforementioned term “observable” refers to being able to resolve the same feature information in the streaming image of the current frame CF_{H2} (same as the feature information previously resolved from the current frame CF_{H1}) and having confidence in determining that the map points MP4, MP5 and MP6 in the streaming image of the current frame CF_{H2} correspond to the same map points in the real environment RW.

In some embodiments, when a specific amount (e.g., 50%) of the map points in the keyframe viewport data D_{KVD} stored in the keyframe viewport database DB are observable in the current frame CF_{H}, the current frame CF_{H} can be regarded to be qualified.

In aforesaid embodiments, the shared keyframe criteria considers a matched number of map points between the current frame CF_{H} (captured by the camera 121 on the head-mounted display device 120) and the keyframe viewport data D_{KVD} (associated with the tracker keyframe K_{T} from the camera tracker 140).

In some other embodiments, the shared keyframe criteria further includes a timing requirement. In step S209, the processor 122 further counts a time gap since the head-mounted display device 120 establishing a latest keyframe. If the time gap is too narrow (e.g., shorter than 1 second), it is not allowed to establish another keyframe. It can avoid generating a lot of similar keyframes in a short time period, so as to reduce a computation loading.

In this case, the current frame (e.g., the current frame CF_{H2} as illustrated in FIG. 6) is able to observe the sufficient number of the map points carried in the keyframe viewport data D_{KVD} and the time gap exceeds a threshold length (e.g., 2 seconds), the current frame CF_{H} is qualified as meeting the shared keyframe criteria.

When the current frame CF_{H} meets the shared keyframe criteria, step S210 is executed by the processor 122 of the head-mounted display device 120, to establish the shared keyframe K_{S} based on the current frame CF_{H}.

In this case, step S211 is executed to remove the map points MP4, MP5 and MP6 observable in the current frame (e.g., the current frame CF_{H2} as illustrated in FIG. 6) from the keyframe viewport database DB and update the mapdata M_{HMD}. In this case, the head-mounted display device 120 will no longer search for the removed map points MP4, MP5 and MP6 in following captured frame (in step S209). The shared keyframe K_{S} will be added into the the mapdata M_{HMD} for tracking.

In response to that the shared keyframe K_{S} is established, step S212 is executed to transmit the shared keyframe K_{S} from the head-mounted display device 120, through the transceiver circuit 123 and the transceiver 143, to the camera tracker 140. As mentioned above, the mapdata M_{TRK} stored in the camera tracker 140 may already include one or more tracker keyframe(s) previously captured by the camera 141. In this case, the processor 142 is configured to execute step S213 to update the mapdata M_{TRK} by adding the shared keyframe K_{S} (sent from the head-mounted display device 120) into the mapdata M_{TRK}. Accordingly, the head-mounted display device 120 and the camera tracker 140 are able to perform tracking in reference with the common shared keyframe K_{S} stored in the mapdata M_{HMD} and the mapdata M_{TRK}. Therefore, tracking functions on the head-mounted display device 120 and the camera tracker 140 can be aligned accurately.

The tracking method 200 shown in FIG. 3 provides a manner to establish the shared keyframe K_{S} between the head-mounted display device 120 and the camera tracker 140, based on the keyframe viewport data D_{KVD} from the camera tracker 140. However, this disclosure is not limited thereto.

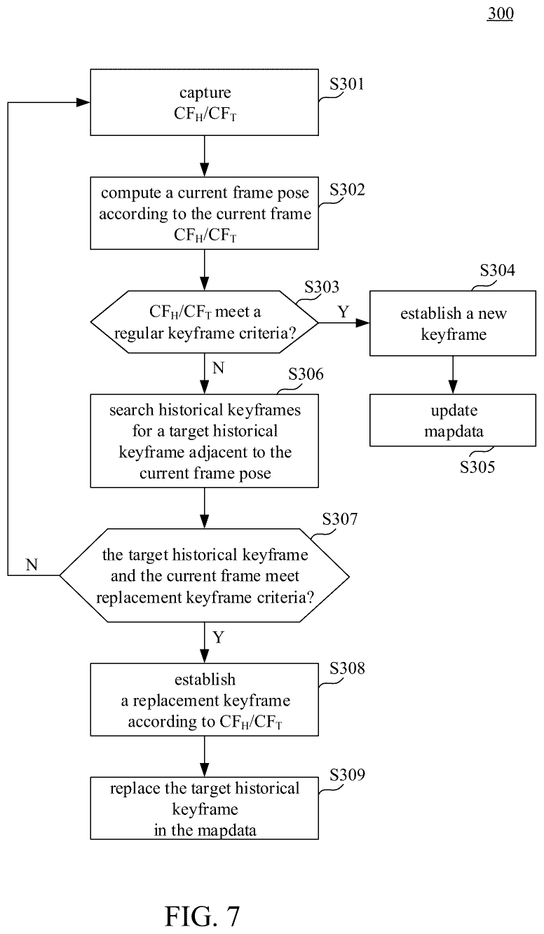

Reference is further made to FIG. 7, which is a flow chart of a tracking method 300 according to some embodiments of the disclosure. The tracking method 300 can be executed by a tracking device. The tracking device can be the head-mounted display device 120 or the camera tracker 140.

For brevity, the tracking method 300 shown in FIG. 7 performed on the head-mounted display device 120 is discussed in the following paragraphs. However, the tracking method 300 shown in FIG. 7 can be performed on the camera tracker 140.

As shown in FIG. 1 and FIG. 7, step S301 is executed by the camera 121 of the head-mounted display device 120, to capture a current frame CF_{H}. Step S302 is executed by the processor 122 of the head-mounted display device 120 to compute a current frame pose according to the current frame CF_{H}. The frame pose refers to the position and orientation of camera 121 while capturing the current frame CF_{H}.

Step S303 is executed by the processor 122 of the head-mounted display device 120 to determine whether the current frame CF_{H} meets regular keyframe criteria. The regular keyframe criteria includes whether a feature difference level between the current frame CF_{H} and the historical keyframes K_{H} stored in the head-mounted display device 120 exceeds a feature threshold. In some embodiments, the regular keyframe criteria is about counting a total number of the map points in the current frame CF_{H} matched with known map points existed in the mapdata M_{HMD}.

When the current frame meets the regular keyframe criteria (i.e., the head-mounted display device 120 currently faces an unfamiliar area in the environment), step S304 is executed by the processor 122 of the head-mounted display device 120 to establish a new keyframe based on the current frame CF_{H}. In this case, step S305 is executed to update the mapdata M_{HMD} by adding the new keyframe into the mapdata M_{HMD}.

When the current frame CF_{H} fails to meet the regular keyframe criteria (i.e., the head-mounted display device 120 currently faces a familiar area in the environment), the position of the head-mounted display device 120 can be recognized in reference with historical keyframes K_{H} of the mapdata M_{HMD}, which is already stored in the storage unit 124 of the head-mounted display device.

The tracking method 300 in this embodiment can further checks time validation of the historical keyframes K_{H}. If some of the historical keyframes K_{H} are established long ago, the tracking method 300 offers a manner to replace some out-of-date historical keyframes K_{H} with newly established keyframes.

When the current frame CF_{H} fails to meet the regular keyframe criteria, step S306 is executed by the processor 122 of the head-mounted display device 120 to search historical keyframes K_{H} stored in the head-mounted display device 120 for a target historical keyframe adjacent to the current frame pose. The target historical keyframe with a pose similar to the current frame pose of the current frame CF_{H} is selected from the historical keyframes K_{H}. In other words, the target historical keyframe will cover a field of view similar to the current frame CF_{H}.

Step S307 is executed by the processor 122 of the head-mounted display device 120 to determine whether the target historical keyframe and the current frame meets a replacement keyframe criteria.

In some embodiments, the replacement keyframe criteria includes whether a time gap between a current time point and an established time point of the target historical keyframe exceeds an expiration threshold (e.g., 1 minute).

If the target historical keyframe is established at a recent timing (e.g., at 10 seconds ago), the target historical keyframe is relatively new, such that the replacement keyframe criteria is not met.

If the target historical keyframe is established long ago (e.g., at 5 minutes ago), a time gap between the current time point and the established time point of the target historical keyframe is longer than the expiration threshold. In this case, the target historical keyframe and the current frame meet the replacement keyframe criteria. Step S308 is executed by the processor 122 of the head-mounted display device 120 to establish a replacement keyframe based on the current frame CF_{H} for replacing the target historical keyframe within the mapdata M_{HMD}, which is stored in the storage unit 124 of the head-mounted display device. In this case, some out-of-date historical keyframes K_{H} can be replaced by newly established keyframes.

In some embodiments, the tracking method 300 shown in FIG. 7 can be performed separated from the tracking method 200 shown in FIG. 3.

In some embodiments, the tracking method 300 shown in FIG. 7 can be performed in combination with the tracking method 200 shown in FIG. 3. In an example, steps S302 to S309 in FIG. 7 can be performed by the head-mounted display device 120 after step S208 shown in FIG. 3. In another example, steps S302 to S309 in FIG. 7 can be performed by the camera tracker 140 after step S201 shown in FIG. 3.

Aforesaid embodiments provide an immersive system designed to enhance virtual reality experiences by employing a Head-Mounted Display (HMD) device and a camera tracker to provide precise tracking of user movements. The disclosure uses Simultaneous Localization and Mapping (SLAM) technology to build a dynamic map of the real environment, allowing seamless interaction between the user's physical movements and the virtual environment displayed. The multi-SLAM system allows integration of data from multiple devices (HMD and camera tracker), providing a unified map of the environment and enabling more complex interactions within the virtual environment. The alignment of different map data from separate devices supports collaborative virtual environments where multiple users can interact within the same virtual space with synchronized movements.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A tracking method, comprising:
in response to a camera tracker establishing a tracker keyframe, transmitting a keyframe viewport data associated with the tracker keyframe from the camera tracker to a head-mounted display device;
capturing a current frame by the head-mounted display device;
based on the keyframe viewport data, determining whether the current frame meets shared keyframe criteria;
in response to the current frame meets the shared keyframe criteria, establishing a shared keyframe based on the current frame by the head-mounted display device; and
transmitting the shared keyframe from the head-mounted display device to the camera tracker.

2. The tracking method of claim 1, wherein the keyframe viewport data comprises a plurality of map points appeared in the tracker keyframe, determining whether the current frame meets the shared keyframe criteria comprises:
searching for the map points of the keyframe viewport data in the current frame; and
determining whether the current frame is able to observe a sufficient number of the map points from the keyframe viewport data.

3. The tracking method of claim 2, wherein determining whether the current frame meets the shared keyframe criteria further comprises:
counting a time gap since the head-mounted display device establishing a latest keyframe,
wherein in response to that the current frame is able to observe the sufficient number of the map points and the time gap exceeds a threshold length, the current frame is qualified as meeting the shared keyframe criteria.

4. The tracking method of claim 2, wherein the keyframe viewport data is updated into a keyframe viewport database of the head-mounted display device, the tracking method further comprises:
in response to the current frame meets the shared keyframe criteria, removing the map points observable in the current frame from the keyframe viewport database of the head-mounted display device.

5. The tracking method of claim 1, further comprises:
capturing a tracker current frame by the camera tracker;
determining whether the tracker current frame meets regular keyframe criteria; and
in response to the tracker current frame meets the regular keyframe criteria, establishing the tracker keyframe based on the tracker current frame.

6. The tracking method of claim 1, further comprise:
computing a current frame pose according to the current frame;
determining whether the current frame meets regular keyframe criteria;
in response to that the current frame meets the regular keyframe criteria, establishing a new keyframe based on the current frame;
in response to that the current frame fails to meet the regular keyframe criteria, searching historical keyframes stored in the head-mounted display device for a target historical keyframe adjacent to the current frame pose;
determining whether the target historical keyframe and the current frame meet a replacement keyframe criteria; and
in response to that the target historical keyframe and the current frame meet the replacement keyframe criteria, establishing a replacement keyframe based on the current frame for replacing the target historical keyframe stored in the head-mounted display device.

7. The tracking method of claim 6, wherein the regular keyframe criteria comprises whether a feature difference level between the current frame and the historical keyframes stored in the head-mounted display device exceeds a feature threshold.

8. The tracking method of claim 6, wherein the replacement keyframe criteria comprises whether a time gap between a current time point and an established time point of the target historical keyframe exceeds an expiration threshold.

9. A head-mounted display device, comprising:
a camera, configured to capture a current frame;
a transceiver circuit, configured to receive a keyframe viewport data associated with a tracker keyframe from a camera tracker;
a storage unit, configured to store the keyframe viewport data; and
a processor, coupled with the storage unit, the camera and the transceiver circuit, wherein the processor is configured to:
based on the keyframe viewport data, determine whether the current frame meets shared keyframe criteria;
in response to the current frame meets the shared keyframe criteria, establish a shared keyframe based on the current frame; and
trigger the transceiver circuit to transmit the shared keyframe to the camera tracker.

10. The head-mounted display device of claim 9, wherein the keyframe viewport data comprises a plurality of map points appeared in the tracker keyframe, the processor is configured to:
search for the map points of the keyframe viewport data in the current frame; and
determine whether the current frame is able to observe a sufficient number of the map points from the keyframe viewport data.

11. The head-mounted display device of claim 10, wherein the processor is further configured to:
count a time gap since the head-mounted display device establishing a latest keyframe,
wherein in response to that the current frame is able to observe the sufficient number of the map points and the time gap exceeds a threshold length, the current frame is qualified as meeting the shared keyframe criteria.

12. The head-mounted display device of claim 10, wherein the keyframe viewport data is updated into a keyframe viewport database stored in the storage unit, the processor is further configured to:
in response to the current frame meets the shared keyframe criteria, removing the map points observable in the current frame from the keyframe viewport database.

13. The head-mounted display device of claim 9, wherein the storage unit is configured to store a plurality of historical keyframes, the processor is further configured to:
compute a current frame pose according to the current frame;
determine whether the current frame meets regular keyframe criteria;
in response to that the current frame meets the regular keyframe criteria, establish a new keyframe based on the current frame;
in response to that the current frame fails to meet the regular keyframe criteria, search the historical keyframes stored in the storage unit for a target historical keyframe adjacent to the current frame pose;
determine whether the target historical keyframe and the current frame meet a replacement keyframe criteria; and
in response to that the target historical keyframe and the current frame meet the replacement keyframe criteria, establish a replacement keyframe based on the current frame for replacing the target historical keyframe stored in the storage unit.

14. The head-mounted display device of claim 13, wherein the regular keyframe criteria comprises whether a feature difference level between the current frame and the historical keyframes stored in the head-mounted display device exceeds a feature threshold.

15. The head-mounted display device of claim 13, wherein the replacement keyframe criteria comprises whether a time gap between a current time point and an established time point of the target historical keyframe exceeds an expiration threshold.

16. A tracking method, comprising:
capturing a current frame by a camera of a tracking device;
computing a current frame pose according to the current frame;
determining whether the current frame meets regular keyframe criteria;
in response to that the current frame meets the regular keyframe criteria, establishing a new keyframe based on the current frame;
in response to that the current frame fails to meet the regular keyframe criteria, searching historical keyframes stored in the tracking device for a target historical keyframe adjacent to the current frame pose;
determining whether the target historical keyframe and the current frame meets a replacement keyframe criteria; and
in response to that the target historical keyframe and the current frame meet the replacement keyframe criteria, establishing a replacement keyframe based on the current frame for replacing the target historical keyframe stored in the tracking device.

17. The tracking method of claim 16, wherein the regular keyframe criteria comprises whether a feature difference level between the current frame and the historical keyframes stored in the tracking device exceeds a feature threshold.

18. The tracking method of claim 16, wherein the replacement keyframe criteria comprises whether a time gap between a current time point and an established time point of the target historical keyframe exceeds an expiration threshold.

19. The tracking method of claim 16, wherein the tracking device is a head-mounted display device.

20. The tracking method of claim 16, wherein the tracking device is a camera tracker.
